(19) United States
(12) Patent Application Publication
(10) Pub. No.: US 2004/0252817 A1
(43) Pub. Date: Dec. 16, 2004

(54) Information service access card

(76) Inventor: Christopher O'Donnell, Gaithersburg, MD (US)

Correspondence Address: Christopher N. O'Donnell, 11 Shuttle Ct., Gaithersburg, MD, 20878, US

(21) Appl. No.: 10/461,686

(22) Filed: Jun. 16, 2003

(51) Int. Cl. H04M 15/00

(52) U.S. Cl. 379/114.2

(57) ABSTRACT

A method is described to provide an access card with information to register and access an associated information service provider. The information service access card (ISAC) is generally of credit card size and weight and presents printed information in the procedural use of the card, a unique card number, promotional images and text and toll free telephone numbers to contact the associated telephone information service provider. The associated information service provides means for secure access through individually registered accounts to information requested by the access card user. This telephone information includes directory assistance, weather reports, date/time, local/national news, traffic conditions, airplane schedules, text to voice translated caller e-mail, account member mailbox messages, universal product code (UPC) product comparison or other information of interest to the local or national caller.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to telecommunications and more specifically it relates to a method and apparatus for providing telephone accessed information services.

2. Description of the Prior Art

It can be appreciated that telephone carriers have made telephone services available as network features through assigned dialing numbers and prepaid calling cards to subscribers and non-subscribers for years. Telephone companies publish specific access telephone numbers for subscriber use that include the popular “411” for directory assistance or “611” or similar for customer service on a wireless network. Well known toll free long distance numbers are assigned the “800” or “888” or similar prefix. Telephone carriers may also offer subscribers calling cards to facilitate long distance telephone calls when the subscriber is away from their home telephone. Generally, these cards indicate a telephone number and unique account number to access the carrier network. In use, the subscriber simply dials the carrier network access number and, when prompted, the unique account number and finally, the destination telephone number. The subscriber is later billed in the usual fashion, the monthly bill, for each call placed through the calling card. These cards are popular among traveling business employees and family members.

The well known prepaid calling card has gained popularity over the years since it provides an inexpensive and easy method for non subscribers to place a long distance call from any telephone. Prepaid cards are widely available at retail stores generally located near the point of sale or cash register. The prepaid card represents a block of call time or telephone use in minutes as related to the purchase price. For example, a $10.00 card provides 200 minutes of “talk” time and a $5.00 card may provide 50 minutes of “talk” time where the total time versus price is the difference in competing prepaid calling card offers. These cards are activated when purchased at the point of sale. Other type prepaid calling cards are activated before they reach the store or purchaser. The user must remove or scratch off a covering over a unique numerical access code to use in the normal dialing routine. These types of prepaid cards are falling in disuse, except when used for promotions, since they are active without user purchase.

A prepaid card for retail purchases and telephone calls is described in U.S. pat. No. 6,507,644, issued Jan. 14, 2003 titled “Pre-paid Telephone Calling Card Linked to a Stored Value Account” and assigned to WorldCom, Inc. This system combines a retail store based debit type card and prepaid telephone to be more convenient with enhanced features and financially more appealing (cheaper) to card users.

A prepaid card that provides a card user to purchase goods and services including telephone services is described in U.S. Pat. No. 6,473,500, issued Oct. 29, 2002 titled “System and Method for Using a Prepaid Card” and assigned to MasterCard International Incorporated. This prepaid card is used like a debit card only authorization to use the card is based on a PIN selected by the customer and the monetary amount available on a deposit account rather than available credit.

Unfortunately, prior art designs of telephone cards do not include a method that provides the card user procedural information to access a telephone information provider that supplies information and services by request to the card user. This telephone information includes directory assistance, weather reports, date/time, local/national news, traffic conditions, airplane schedules, text to voice translated caller e-mail, account member mailbox messages or other information of interest to the local or national caller.

Also, conventional telephone cards do not include a method that provides a card user access to a telephone information service that is not the network carrier used to connect the call.

An alternative telephone access card is needed to correct the problems of the prior art methods. This alternative resource facilitates efficient and secure access to an associated telephone information services provider. This access card, with user activation, enables the user access to information through any landline or wireless telephone system.

In these respects, the present inventive solution substantially departs from the conventional concepts, methods and apparatus designs of the prior art, and in so doing provides a method for the purpose of providing an access card to access an associated telephone information service provider.

### SUMMARY OF THE INVENTION

The present invention provides a method for an information card to facilitate telephone user access to an associated telephone information service provider. The information service access card (ISAC) is generally of credit card size and weight and presents printed information in the procedural use of the card, a unique card number, promotional images and information and toll free telephone numbers to contact the associated telephone information service provider. The associated information service provider provides means for secure access through individually registered accounts to information requested by the card user. This telephone information includes directory assistance, weather reports, date/time, local/national news, traffic conditions, airplane schedules, text to voice translated caller e-mail, account member mailbox messages, Universal Product Code (UPC) product comparison or other information of interest to the local or national caller.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a method that will overcome the shortcomings of the prior art devices.

An object is to provide a telephone information access card that provides procedural information to access an associated telephone information provider.

Another object is to provide a telephone access information access card that provides access to a telephone information service that is not the network carrier used to connect the call.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

FIG. 1 is a flow chart of the steps the access card is used to set-up an account with the associated information services provider.

FIG. 2 is a flow chart of the steps the access card facilitates to access the associated information service provider.

### DESCRIPTION OF THE PREFERRED EMBODIMENT

The associated information service is the subject of a co-pending non-provisional application; Ser. No. ______ filed on Jun. 02, 2003 and is hereby incorporated by reference into this application.

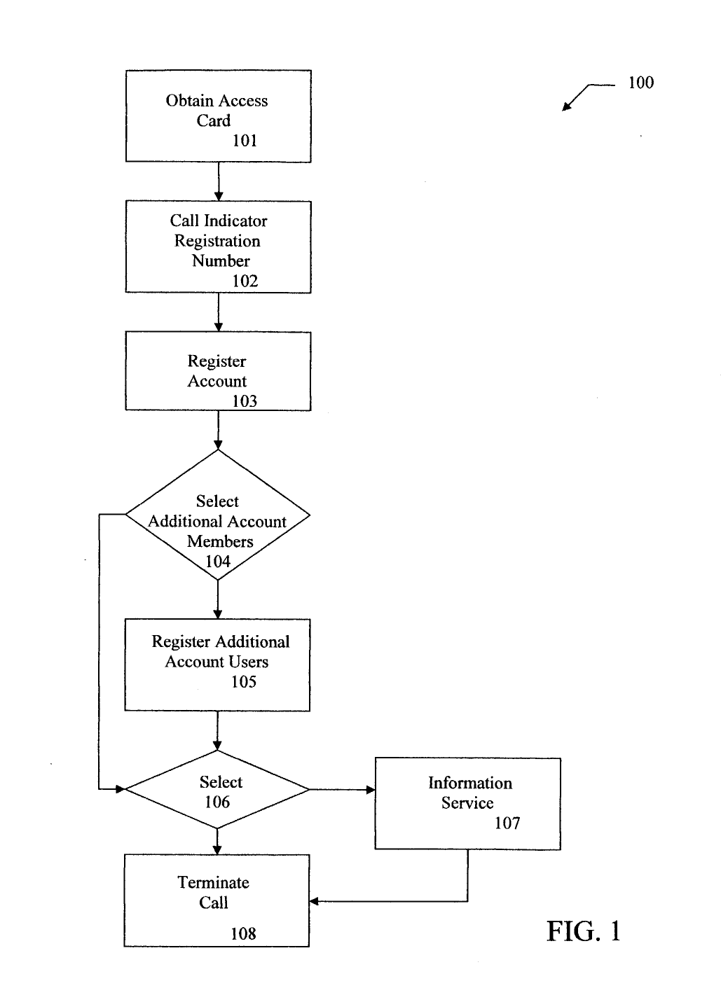

FIG. 1 illustrates the procedural steps 100 in which the Information Service Access Card (ISAC) is used to set-up the access card user account with the associated telephone information service provider. In the first step 101, the access card user has received the access card as a gift, purchased and activated the card at a retail store or has received an access card charged with free calls in a promotional distribution. The physical size and weight of the access card will vary with presentation decisions but will generally be round, square or rectangular in shape and made of a thin ½ oz., 1 mm thick plastic or heavy paper product. It is primarily configured to be easy to read and convenient to carry in a wallet, handbag, pants pocket or other common everyday portable container and handy to the telephone user. The card exhibits printed information on one side or both that includes the information services offered, access information and promotional messages.

The telephone information service that is accessed by ISAC, or “associated” with ISAC, is also indicated on the face of the access card. The associated service provider may be geographically located in one or several places and provides directory assistance, weather reports, date/time, local/national news, traffic conditions, airplane schedules, text to voice translated caller e-mail, account member mailbox messages, Universal Product Code (UPC) product comparison or other information of interest to the local or national caller that utilizes ISAC. This associated information service may be a feature or intelligent services platform of a telephone carrier provider. It is preferable that the associated telephone information service is not part of the network carrier used to connect the call but an independent service facility.

In the preferred configuration, ISAC is the size and weight of a typical plastic credit card commonly issued by banking institutions. The front of the card identifies the telephone information service, the list of information services offered and the cost per call if any fee is required. ISAC may be distributed with a set number of free service calls, typical to promotions of a product ISAC is associated with or for the promotion of ISAC itself. In this embodiment, ISAC will clearly indicate the offered number of free service calls. The back of the access card will present toll free registration and service telephone numbers and all procedural and other pertinent information including registering, using and re-charging the monetary deposit account managed by the associated information service provider. The back of the card will also include a serial/identification number unique to each card to be used in the registration process and optionally as part of the authentication step prior to use of the information service. The card back may also include Website addresses and service disclaimers along with the corporate logo of the concern that issued or sponsored the access card.

In a first embodiment, ISAC will be available for purchase and activation at the point of sale in a retail store in the conventional fashion of prepaid telephone long distance calling or gift cards. The face of ISAC will indicate the number of calls provided at the purchase price. In the preferred embodiment, the card is obtained free of charge with instructions to provide a monetary deposit under the unique card/account number during registration with the associated information service. If the card has been distributed for free use, the information service will confirm the card value at registration. Note that this access card does not offer cost per minute of “talk” time as is well known in the art for a telephone calling card. This access card provides for a determined number of calls to an information service at an identified set fee per call if any. For example, a $5.00 purchase at activation, or registration deposit, provides for 100 calls. Therefore, the unique user account is debited five cents by the associated information service for each call. The call charge is not restricted to the preferred amount of five cents per call but may be adjusted by the associated information service from no charge to several dollars per call.

In the next step 102 of FIG. 1, the card user begins the procedural steps for registration with the information service printed on ISAC. The card user first dials the indicated toll free registration telephone. The toll free telephone number is commonly recognized by the prefix “888”, “800” or “877”. These national numbers are paid by the called party, not the calling party or, in this case, the access card user. The access card user then follows the registration process, the steps also presented on the access card, as prompted by the information service 103. Registration includes providing the access card indicated unique card/ identification number followed by an authentication code. The code is generally supplied by the access card user or identified by the associated information service and reported to the access card user. The authentication code may be in the form of a password, spoken word or phrase, a touch tone telephone pad sequence or simple caller identification through Caller ID. The authentication code or password provides a level of security to the account holder as is well known in the art. Next, the new account holder is prompted to deposit a specific monetary amount through a credit/debit card deposit process if required. If a deposit is not required, the card value in number of calls and/or monetary amount on deposit is confirmed to the registering card user. The card user is then prompted 104 for additional users. If the card user selects additional account users 105, a unique password is established for each additional member. Additional account members may be added later by the primary account holder through a later call placed to registration of the associated information service. If registration is complete, the card user is prompted to select 106 one of several information services 107 or to terminate the call 108.

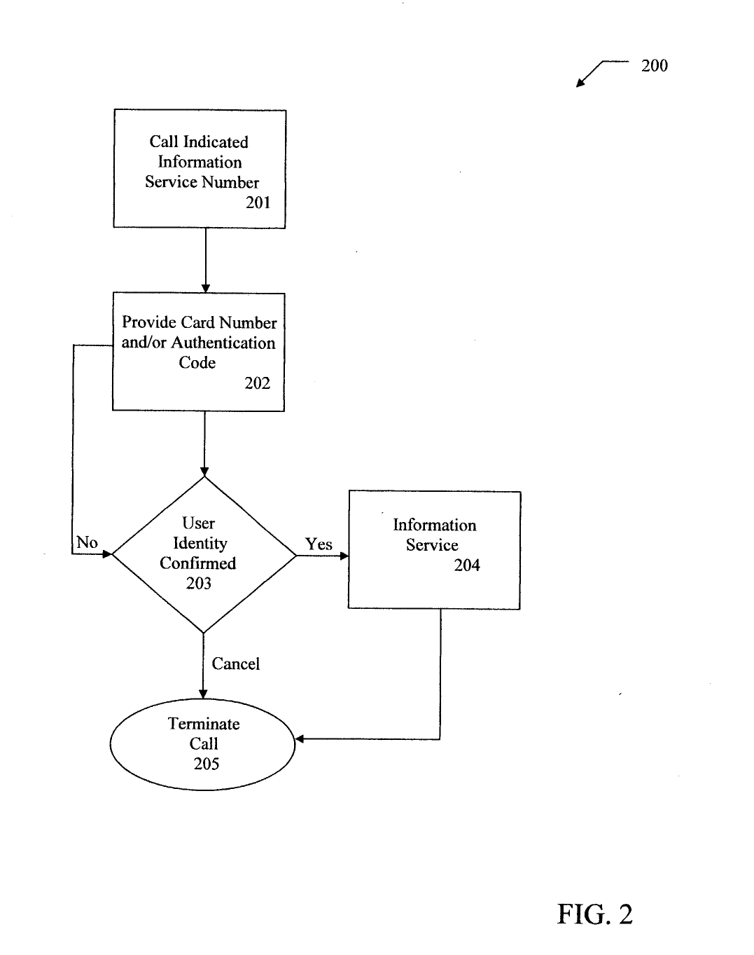

FIG. 2 is a flow chart of the steps 200 the access card facilitates access to the associated information service. To begin, the card user dials the toll free information service number indicated on ISAC 201. Next, the card user is prompted to enter the unique card/account number followed by account password 202. If the user identity is confirmed through a match between the user supplied account number and password and account records 203, the card user may be notified of the account call/monetary balance and invited to select one of several of the information services 204. If the access card user is not authorized due to a zero monetary account balance or unconfirmed identity, the access card user is prompted to reenter identity 202 or terminate the call 205.

The Information Service Access Card provides an easy reference for the next call to the associated information service provider.

The above description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

We claim:

1. A method presented by a telephone access card to register and access an associated information service provider comprising:
identifying access information displayed on said access card;
dialing the indicated registration telephone number;
registering an account, and;
selecting any one of the indicated information services provided by the associated information service provider.

2. A method presented by a telephone access card to access an associated information service provider comprising:
dialing the indicated telephone information service number;
determining an authentication code of the registered account, and;
selecting any one of indicated information services.

3. A method as claimed in claim 1 where said identifying access information comprises information presented on said access card including procedural registration information, procedural re-charge information, a registration telephone number, an information service telephone number, a serial/identification number and said indicated information services.

4. A method as claimed in claim 3 where said registration telephone number is a toll free telephone number and said information service telephone number is a toll free telephone number.

5. A method as claimed in claim 3 where said registration telephone number and said information service telephone number is the same telephone number.

6. A method as claimed in claim 1 where said registering further comprises providing a unique serial/card identification number and a password.

7. A method as claimed in claim 1 where said indicated information services comprises directory assistance, weather reports, date/time, local/national news, traffic conditions, airplane schedules, text to voice translated caller e-mail and account member mailbox messages.

8. A method as claimed in claim 1 or 2 where said associated information service comprises an information service identified on the face of said access card.

9. A method as claimed in claim 8 where said associated information service comprises a telephone information service that is not the network carrier used to connect the call.

10. A method as claimed in claim 2 where said authorization code comprises the unique serial/identification number, password and the telephone number of the calling party.
